(19) United States
(12) Patent Application Publication
(10) Pub. No.: US 2021/0331888 A1
(43) Pub. Date: Oct. 28, 2021

(54) SHEET HOLDER

(71) Applicant: SILHOUETTE AMERICA, INC., Lindon, UT (US)

(72) Inventors: Benjamin LINDSEY, Cedar Hills, UT (US); Mitsuru YOKOYAMA, Irvine, CA (US)

(21) Appl. No.: 16/860,128

(22) Filed: Apr. 28, 2020

(51) Int. Cl. B65H 35/00; B41J 11/70

(52) U.S. Cl. CPC B65H 35/0086; B41J 11/70

(57) ABSTRACT

Provided is a sheet holder capable of suitably holding a cloth sheet medium while a plotter performs processing. The sheet holder is used for a plotter that performs processing on a cloth sheet medium. The sheet holder includes a holder base material on an upper surface of which the sheet medium is mounted, and an engaging sheet attached onto the holder base material and including a plurality of hook-shaped engaging elements to be engaged with the sheet medium. The engaging elements are arranged so as to be arranged in a plane shape at predetermined intervals on the holder base material.

### BACKGROUND OF THE INVENTION

The present invention relates to a sheet holder, specifically, to a sheet holder configured to hold a sheet medium while a plotter performs processing on the sheet medium.

Conventionally, a plotter is known which forms a predetermined image or a cut image on a sheet medium by operating a carriage holding a pen or a cutter in a direction intersecting a conveying direction of the sheet medium while conveying the sheet medium by a rotating operation of drive rollers in a state where the sheet medium is sandwiched by the drive rollers and pressure rollers after the sheet medium is mounted on a mounting table.

Also, a technique is known in which a sheet holder serving as an underlay of a sheet medium is adhered in a peelable manner in advance to the sheet medium so as to prevent the sheet medium from bending during image drawing or cutting by a plotter (refer to, for example, Japanese Unexamined Patent Application Publication No. H05-69695 ('695 Document) and US Patent Application Publication No. 2015/0273717 ('717 Document)).

The pen plotter described in the '695 Document can draw images on a sheet medium with a high drawing pressure by being configured so that, after a sheet holder is adhered to the reverse side of the sheet medium as a medium on which images are drawn, while the sheet medium is conveyed, a pen is simultaneously operated in a direction perpendicular to the conveying direction.

At this time, the sheet holder is configured such that an adhesive agent is applied onto a holder base material in the form of a plurality of spots.

In order to hold tissue paper in particular, the sheet holder described in the '717 Document is configured such that circular adhesive spots are provided in a staggered pattern on the holder base material.

With the configuration described above, the sheet medium can be held so as not to bend during processing by a plotter, and the sheet medium can be peeled off without causing wrinkles and curls after processing.

While a sheet holder as described above uses an adhesive agent to hold a sheet medium, in a case where the sheet medium is a cloth sheet made of a fibrous material, for example, felt or the like, it is difficult to adhere the cloth sheet onto the sheet holder. A major reason for this is that the adhesive strength of a common adhesive agent is insufficient, so that the cloth sheet is displaced during processing, and accurate processing cannot be performed. Therefore, the sheet medium cannot be suitably held while a plotter performs processing.

Also, in some cases, when the cloth sheet is peeled off from the sheet holder after processing, fibers remain on the sheet holder to degrade the adhesive power, and wear of the sheet holder accelerates.

In particular, when the plotter is a cutting plotter to be used mainly for forming cut images, a cut image as a portion of the cloth sheet is peeled off from the sheet holder, so that fibers easily remain on the sheet holder, and wear of the sheet holder accelerates even more.

### SUMMARY OF THE INVENTION

The present invention has been made in view of the above-described problem, and an object of the present invention is to provide a sheet holder capable of suitably holding a cloth sheet medium while a plotter performs processing.

Another object of the present invention is to provide a sheet holder from which a cloth sheet medium can be suitably peeled off after processing by a plotter (in particular, a cutting plotter).

The above-described problem can be solved by a sheet holder of the present invention which, for example, is a sheet holder to be used for a plotter that performs processing on a cloth sheet medium, and includes a holder base material on an upper surface of which the sheet medium is mounted, and an engaging sheet attached onto the holder base material and including a plurality of hook-shaped engaging elements to be engaged with the sheet medium, wherein the engaging elements are arranged in a plane shape at predetermined intervals on the holder base material.

With the above-described configuration, a sheet holder which is capable of suitably holding a cloth sheet medium during processing by a plotter, and from which the cloth sheet medium can be suitably peeled off after processing, can be realized.

Specifically, a sheet holder includes a plurality of hook-shaped engaging elements in place of an adhesive agent, and the engaging elements are arranged in a plane shape, so that by engaging the engaging elements arranged in a plane shape with the sheet medium, the cloth sheet medium can be held, and the cloth sheet can be peeled off.

More specifically, a dedicated sheet holder used for a plotter enables suitably attaching and detaching a cloth sheet medium by applying the technology of a hook-and-loop fastener.

At this time, it is preferable that the sheet holder is used for the plotter that performs a cutting process by conveying the sheet medium in a conveying direction intersecting the moving direction of a carriage holding a cutter while moving the carriage in a state where the cutter is in contact with or separated from the sheet medium, and the holder base material is conveyed along the conveying direction together with the sheet medium in a state where the sheet medium is mounted on the upper surface of the holder base material, and the sheet holder further includes a bonding sheet that is provided between the holder base material and the engaging sheet and that bonds the engaging sheet onto the holder base material.

As described above, when the plotter is a cutting plotter to be used mainly for forming cut images, the sheet holder holds a cut image as a portion of the sheet medium during a cutting process, and a high holding force caused by the sheet holder is required, so that the effect of the sheet holder according to the present invention is excellent.

In addition, since the cut image needs to be easily peeled off from the sheet holder after a cutting process, the effect of the sheet holder according to the present invention is excellent.

Further, the sheet holder further includes a bonding sheet that is provided between the holder base material and the engaging sheet and that bonds the engaging sheet onto the holder base material, so that the engaging elements arranged in a plane shape can be easily attached onto the holder base material.

At this time, it is preferable that a plurality of engaging element rows each consisting of a plurality of the engaging elements arranged along the conveying direction are formed and arranged along the moving direction, and the positions of the respective engaging elements constituting one of two engaging element rows adjacent to each other and the positions of the respective engaging elements constituting the other engaging element row are different from each other in the conveying direction, and the alignments of the respective engaging elements common to one engaging element rows and the alignments of the respective engaging elements common to the other engaging element rows are alternately arranged in the moving direction.

In general, when a plotter performs a cutting process on a sheet medium in an inclined direction with respect to a conveying direction, it is necessary to simultaneously move a carriage while the sheet medium is conveyed in the conveying direction, and a large load due to a cutting pressure is applied to the sheet medium.

Therefore, in the case of the arrangement pattern of the engaging elements in the configuration described above, even when a large load is applied to the sheet medium by performing a cutting process on the sheet medium in the inclined direction, the sheet medium can be held so as not to bend, and can be easily peeled off.

In other words, the engaging elements are regularly arranged at even intervals and are arranged at a high surface density as compared with a case where they are arranged in an orthogonal grid pattern, so that during a cutting process by a plotter, the sheet medium can be held so as to become more difficult to bend, and after processing, the sheet medium can be more easily peeled off.

Because the engaging elements are arranged as described above, an arrangement pattern is obtained in which, when a cutter operates, the cutter and the engaging elements easily overlap vertically. Therefore, the sheet holder can hold a sheet medium so that the sheet medium becomes more difficult to bend during a cutting process.

At this time, it is preferable that the engaging elements are formed into substantially T shapes, and each of the engaging elements includes an element main body portion extending upward from the upper surface of the holder base material, and a pair of engaging portions projecting to sides opposite to each other in a direction perpendicular to the extending direction of the element main body portion from an extending end portion of the element main body portion, and the pair of engaging portions respectively project along the conveying direction or the moving direction.

With the configuration described above, for example, as compared with a case where the engaging elements have J shapes, the engaging elements can be made thicker, and the engaging elements can be improved in durability.

In addition, each engaging element is formed into a substantially T shape and has a pair of engaging portions, so that the force to hold a cloth sheet medium can be improved.

These are obtained by specializing the functionality and operability specific to a sheet holder to be used for a cutting plotter. Specifically, durability against repeated attachment and detachment of a cloth sheet medium is secured, and holding performance against a cutting pressure applied during a cutting process is secured. The size of a minimum cut image to be formed after a cutting process is assumed to be approximately 1 cm², and a sheet holder capable of holding even this minimum cut image is realized.

At this time, it is preferable that the element main body portion is formed to become narrower in width as it extends upward from the upper surface of the holder base material, and the engaging portions project from the extending end portion of the element main body portion while curving downward, and at a central portion of an upper surface of the engaging element, a recessed portion recessed toward the holder base material side is formed.

As described above, the element main body portion is formed so as to become narrower in width as it extends upward from the upper surface of the holder base material, and the engaging portions project from the extending end portion of the element main body portion while curving downward, so that an engagement force caused by the engaging elements with respect to the sheet medium can be further improved.

In addition, the engaging portions project from the extending end portion of the element main body portion while curving downward, so that a sheet medium is easily slid on the upper surfaces (curved surfaces) of the engaging elements, and fine positioning of the sheet medium becomes easier with respect to the sheet holder. The sheet medium can also be engaged without much damage. After the sheet medium is pushed into the engaging elements, the sheet medium can be suitably held.

In addition, at the central portion of the upper surface of the engaging element, a recessed portion recessed toward the holder base material side is formed, so that when a cutter operates during a cutting process, the cutter can be suppressed from coming into contact with the engaging elements. As a result, durability of the engaging elements can be improved.

At this time, it is preferable that the engaging sheet is a transparent or translucent sheet, and of the upper surface of the holder base material, in an attaching region to which the engaging sheet is attached, grid-shaped reference lines for engaging the sheet medium with a predetermined position are formed.

With the configuration described above, a user can visually recognize the grid-shaped reference lines formed on the upper surface of the sheet holder, and accordingly, can suitably attach a sheet medium to a desired position on the upper surface of the sheet holder.

At this time, it is preferable that, on the upper surface of the holder base material, an attaching region which is provided at a predetermined interval inside an outer peripheral edge of the holder base material, and to which the engaging sheet is attached, and a frame-shaped non-attaching region which is provided outside the attaching region and to which the engaging sheet is not attached, are formed.

In general, a cutting plotter sandwiches a sheet medium mounted on a mounting table by drive rollers and pressure rollers, and conveys the sheet medium by a rotating operation of the drive rollers. At least a pair of drive rollers (pressure rollers) are disposed at positions corresponding to both end portions in a width direction of the sheet medium.

Therefore, as described above, by configuring a cutting plotter such that the engaging sheet (engaging elements) is not attached to positions corresponding to where the drive rollers (pressure rollers) pass through on the upper surface of the sheet holder, the engaging sheet can be prevented from being pressed by the drive rollers (pressure rollers). As a result, durability of the sheet holder can be secured.

### DESCRIPTION OF THE DRAWINGS

FIG. 1 is a perspective view of a sheet holder and a plotter of an embodiment.

FIG. 2 is a plan view of the sheet holder.

FIG. 3 is an essential portion enlarged view of the sheet holder.

FIG. 4 is a sectional view of the sheet holder taken along IV-IV, showing engaging elements.

FIG. 5 is a plan view of an engaging sheet, showing engaging elements.

FIG. 6A is a perspective view of the engaging sheet (engaging elements).

FIG. 6B is a perspective view of an engaging sheet according to a second embodiment.

FIG. 6C is a perspective of an engaging sheet according to a third embodiment.

FIG. 6D is a perspective of an engaging sheet according to a fourth embodiment.

FIG. 6E is a perspective of an engaging sheet according to a fifth embodiment.

FIG. 6F is a perspective of an engaging sheet according to a sixth embodiment.

### DETAILED DESCRIPTION OF THE INVENTION

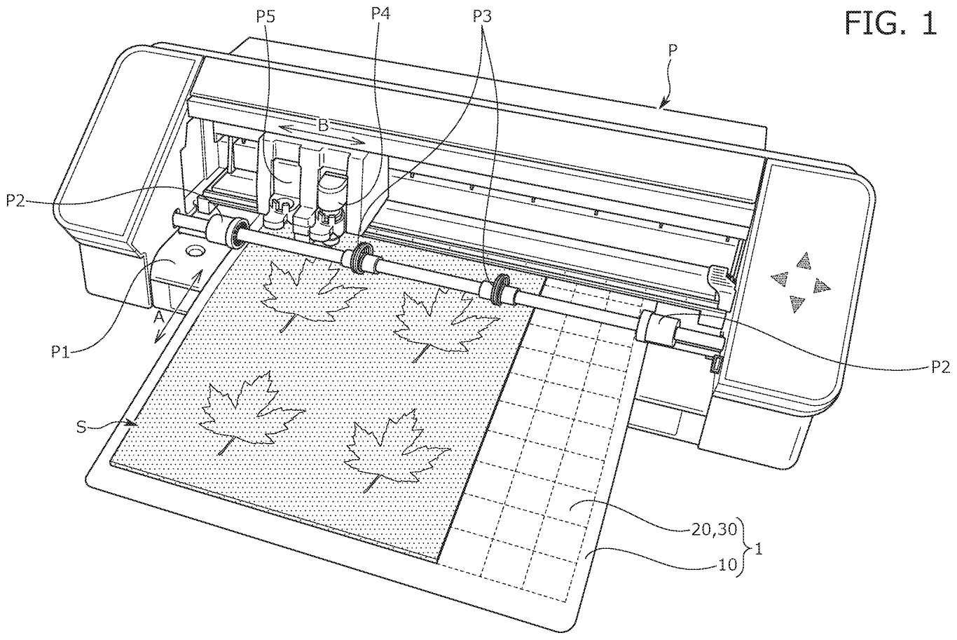

Hereinafter, embodiments of the present invention are described with reference to FIG. 1 to FIG. 6F.

The present embodiment relates to an invention of a sheet holder which is used for a plotter that performs processing on a cloth sheet medium, and holds the sheet medium while the plotter performs processing, and is configured to include a holder base material on an upper surface of which the sheet medium is mounted, and an engaging sheet that is attached onto the holder base material and includes a plurality of hook-shaped engaging elements to be engaged with the sheet medium, wherein the engaging elements are arranged so as to be arranged in a plane shape at predetermined intervals on the holder base material.

As shown in FIG. 1, the plotter P corresponds to a cutting plotter, and performs a cutting process by operating a carriage P5 holding a cutter P4 in a direction intersecting a conveying direction A while conveying a sheet medium S by a rotating operation of drive rollers P2 in a state where the sheet medium S mounted on a mounting table P1 is sandwiched by the drive rollers P2 and pressure rollers P3.

More specifically, the plotter P forms a predetermined cut image on the sheet medium S by operating the carriage P5 holding the cutter P4 in a moving direction B perpendicular to the conveying direction A in a state where a tip end of the cutter P4 is brought into pressure contact with or separated from the sheet medium S while conveying the sheet medium S.

The plotter P does not have to be particularly limited to a cutting plotter. For example, the plotter P may be a pen plotter or the like which is caused to hold a pen in place of the cutter P4 and draw a predetermined image on a sheet medium S.

The sheet medium S is a cloth sheet, and more specifically, a sheet formed by using, as a raw material, natural fibers such as cotton, hemp, silk, and wool, and synthetic fibers (regenerated fibers) such as polyester, acetate, rayon, and nylon. Specifically, the sheet medium is a fibrous article such as felt, nonwoven fabric, woven fabric, and a knit.

The sheet medium S may be a sheet other than the cloth sheet as long as it is capable of being engaged by using a hook-and-loop fastener.

The sheet holder 1 of the present embodiment is used as an underlay of the sheet medium S while the plotter P performs a cutting process on the sheet medium S as shown in FIG. 1 to FIG. 5.

The sheet holder 1 mainly consists of a holder base material 10 that is conveyed in a conveying direction A together with the sheet medium S in a state where the sheet medium S is mounted on an upper surface of the holder base material 10, a bonding sheet 20 that is disposed on the holder base material 10 and has adhesiveness, and an engaging sheet 30 that is disposed on the bonding sheet 20 and is engaged with the sheet medium S.

On an upper surface of the engaging sheet 30, hook-shaped engaging elements 40 are integrally disposed so as to be arranged so as to be arranged in a plane shape at predetermined intervals.

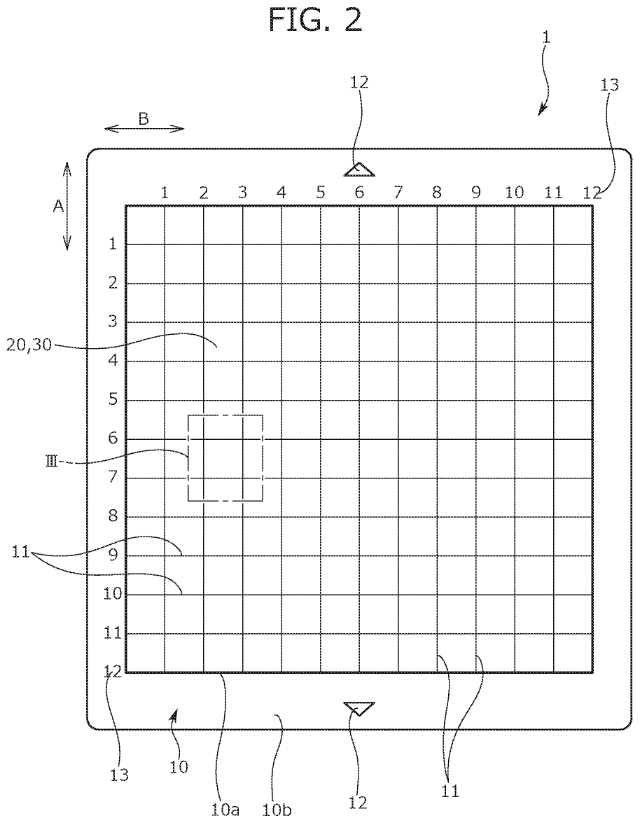

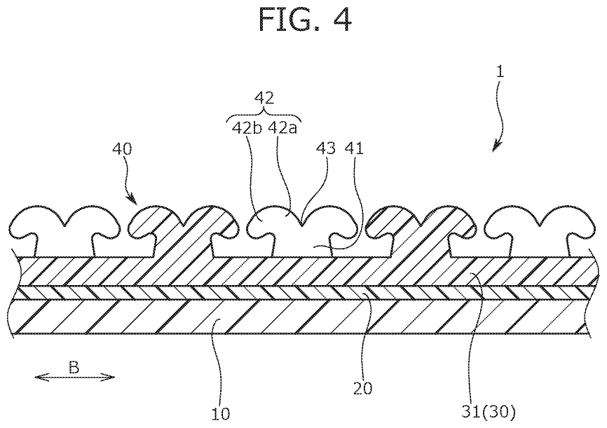

As shown in FIG. 2 and FIG. 4, the holder base material 10 is formed of a substantially rectangular long plastic sheet, and specifically, is formed of an acetate sheet with a thickness of approximately 0.3 mm.

Besides an acetate sheet, the holder base material 10 may be formed of a plastic sheet made of polyethylene terephthalate, polycarbonate, or the like, paperboard for paperware, white paperboard, special paperboard, or the like.

On the upper surface of the holder base material 10, a rectangular attaching region 10a which is provided at a predetermined interval inside an outer peripheral edge of the holder base material 10 and to which the bonding sheet 20 and the engaging sheet 30 are attached, and a frame-shaped non-attaching region 10b which is provided outside the attaching region 10a and to which the bonding sheet 20 and the engaging sheet 30 are not attached, are formed as shown in FIG. 2.

In the attaching region 10a, grid-shaped reference lines 11 serving as indexes for engagement of the sheet medium S with a predetermined position are printed.

Specifically, the reference lines 11 are graduation lines, and extend along the conveying direction A and the moving direction B.

Therefore, a user can confirm the sizes of the sheet medium S and cut images, and can confirm an attachment position of the sheet medium S.

In the non-attaching region 10b, at central portions of both end portions in the conveying direction A, arrow marks 12 showing a setting direction (conveying direction A) of the sheet medium S are printed.

At one end portion of the non-attaching region 10b in the conveying direction A, graduations 13 are printed along the reference lines 11. At one end portion of the non-attaching region 10b in the moving direction B as well, graduations 13 are printed.

Both end portions of the non-attaching region 10b in the moving direction B correspond to portions that respectively come into contact with the drive rollers P2 of the plotter P shown in FIG. 1.

As shown in FIG. 4, the bonding sheet 20 is formed of a rectangular long sheet with adhesiveness, and specifically, is formed as a transparent or translucent bonding film with a thickness of approximately 0.1 mm.

The bonding sheet 20 is provided between the holder base material 10 and the engaging sheet 30, and bonds the engaging sheet 30 onto the holder base material 10.

The bonding sheet 20 is required to have an adhesive strength capable of bonding the engaging sheet 30, and the kind of bonding adhesive is not particularly limited.

Preferably, the bonding sheet 20 is transparent or translucent. This makes it easy for a user to visually recognize the reference lines 11 formed on an upper surface of the sheet holder 1.

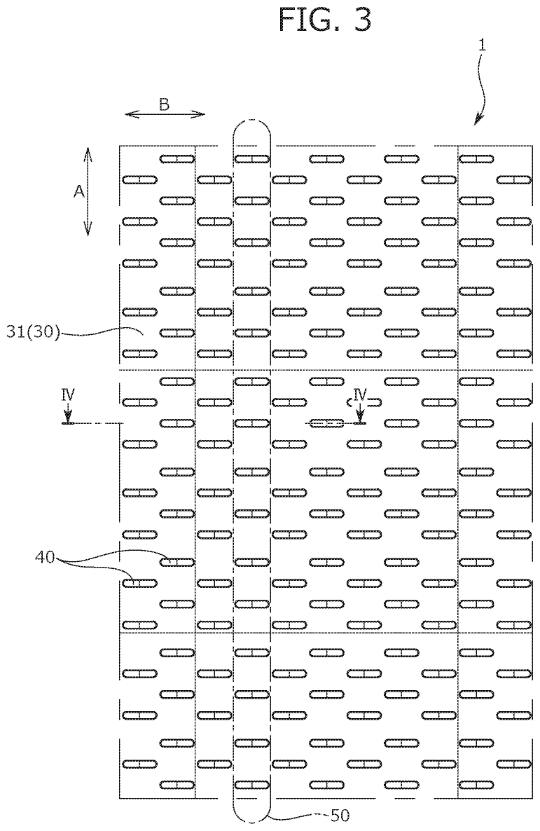

As shown in FIG. 3 to FIG. 5, the engaging sheet is formed of a rectangular long plastic sheet, and specifically, is formed of a transparent or translucent nylon sheet with a thickness of approximately 0.6 mm.

Besides a nylon sheet, the engaging sheet 30 may be formed of a plastic sheet made of polyolefin-based resin, polyester-based resin, polyvinyl chloride-based resin, or the like.

The engaging sheet 30 mainly consists of a sheet-shaped sheet main body 31 with a thickness of approximately 0.2 mm, and a plurality of hook-shaped engaging elements 40 with a height of approximately 0.4 mm projecting from an upper surface of the sheet main body 31. The sheet main body 31 and the engaging elements 40 are integrally molded.

As shown in FIG. 3 to FIG. 5, the engaging element 40 is an engagement hook (micro engagement hook) with a substantially T-shaped longitudinal section, and the plurality of engaging elements 40 are arranged so as to form a plane shape at predetermined intervals on the holder base material 10.

In other words, the plurality of engaging elements 40 are two-dimensionally spread and arranged at predetermined intervals in a predetermined region on the holder base material 10.

The engaging element 40 is an engagement hook that is long along the moving direction B, and a width in a long-length direction of the engaging element 40 is approximately 0.8 mm, and a width in a short-length direction of the engaging element 40 is approximately 0.2 mm.

The engaging element 40 includes, as shown in FIG. 4, an element main body portion 41 extending upward from the upper surface of the holder base material 10, and a pair of engaging portions 42 projecting in a direction (moving direction B) perpendicular to the extending direction of the element main body portion 41 from an extending end portion of the element main body portion 41.

At a central portion of an upper surface of the engaging element 40, a recessed portion 43 with a substantially inverted triangular longitudinal section recessed toward the holder base material 10 side is formed.

The element main body portion 41 has a substantially rectangular transverse section, and is formed to become narrower in width in the long-length direction of the engaging element 40 as it extends upward from the upper surface of the holder base material 10.

The pair of engaging portions 42 project to sides opposite to each other from the extending end portion of the element main body portion 41 in the long-length direction of the engaging element 40, and extend while slightly curving downward.

More specifically, the engaging portion 42 includes a first projecting portion projecting outward while slightly extending upward from the extending end portion of the element main body portion 41, and a second projecting portion bending continuously from a projecting end portion of the first projecting portion 42a and projecting outward while slightly extending downward. Moreover, an upper surface of the engaging portion 42 is formed into a smoothly curved surface.

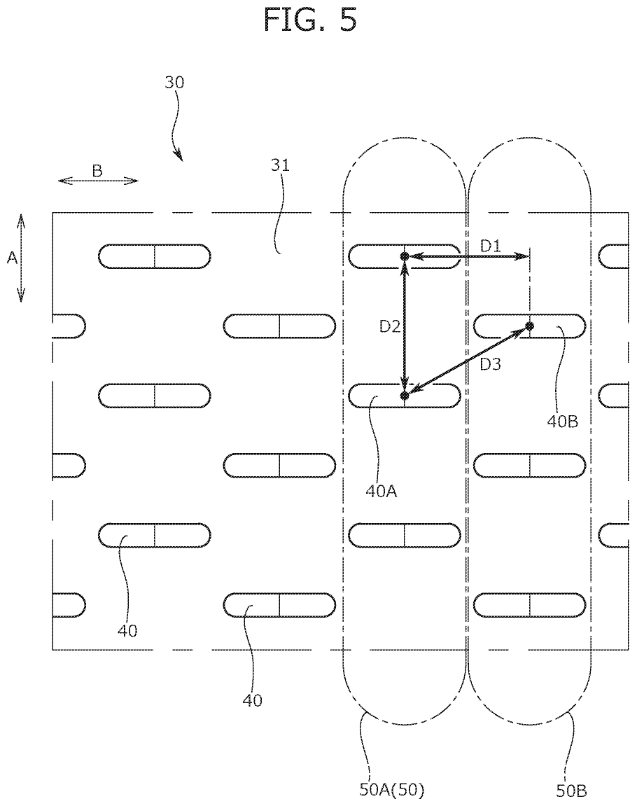

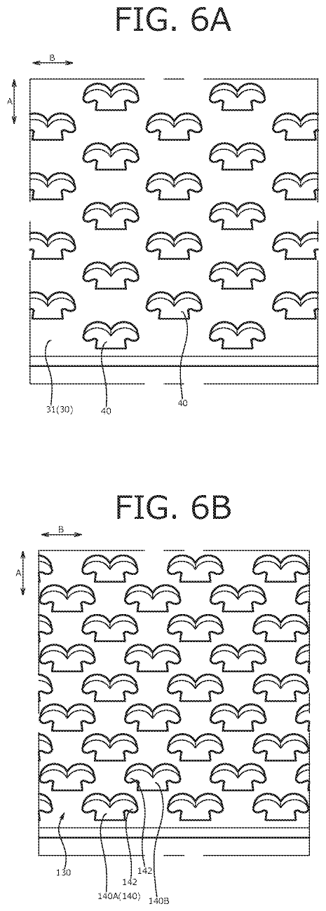

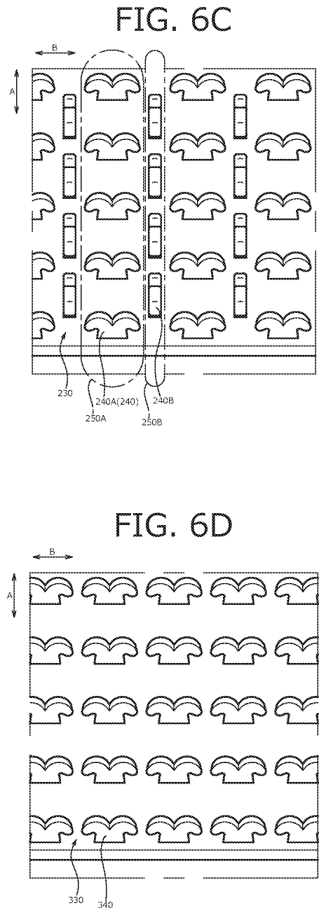

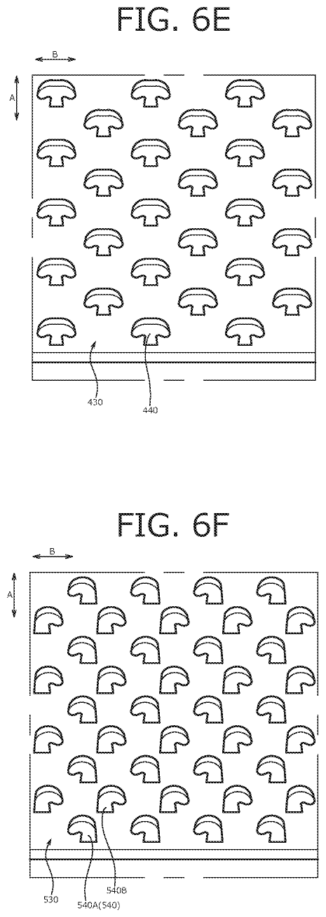

Next, an arrangement pattern of the engaging elements 40 is described based on FIG. 5 and FIG. 6A.

The engaging elements 40 are arranged at predetermined intervals in a staggered pattern.

Specifically, an engaging element row 50 is formed by arranging a plurality of engaging elements 40 along the conveying direction A. Moreover, a plurality of engaging element rows 50 are formed and arranged along the moving direction B.

At this time, with two engaging element rows 50A and 50B adjacent to each other, the positions of the respective engaging elements 40 constituting the engaging element row 50A and the positions of the respective engaging elements 40 constituting the engaging element row 50B are different from each other in the conveying direction A.

The alignments of the respective engaging elements 40 common to the engaging element rows 50A and the alignments of the respective engaging elements 40 common to the engaging element rows 50B are formed in a pattern in which they are alternately arranged in the moving direction B.

An interval D1 in the moving direction B between the two engaging element rows 50A and 50B is narrower than an interval D2 in the conveying direction A between the engaging elements 40 constituting the engaging element row 50A.

Specifically, the interval D1 is approximately 0.8 mm, and the interval D2 is approximately 0.9 mm.

An interval D3 between engaging elements 40A constituting the engaging element row 50A and engaging elements 40B constituting the engaging element row 50B and closest to the engaging elements 40A is narrower than the interval D1 and the interval D2.

As described above, by arranging the engaging elements 40 in a staggered pattern, an arrangement pattern is formed which makes it easy for the cutter P4 and the engaging elements 40 to overlap vertically when the plotter P performs a cutting process as compared with a case where they are in an irregular arrangement or an arrangement in an orthogonal grid pattern.

As a result, the sheet holder 1 can hold the sheet medium S so that the sheet medium S becomes less likely to bend during a cutting process by the plotter P. As a result, cut images with high cutting accuracy and an excel finish can be formed.

<Other Embodiments of Engaging Sheet>

Next, other embodiments of the engaging sheet are described based on FIG. 6B to FIG. 6F.

Overlapping descriptions that are in common with respect to the engaging sheet 30 described above are omitted.

Engaging sheets 130, 230, and 330 of second to fourth embodiments are different in the arrangement patterns of the engaging elements as compared with the engaging sheet 30.

Engaging sheets 430 and 530 of fifth and sixth embodiments are different in the shapes of the engaging elements as compared with the engaging sheet 30.

As shown in FIG. 6B, the engaging sheet 130 of the second embodiment is configured so that a surface density of the engaging elements 40 becomes higher than in the engaging sheet 30 shown in FIG. 6A.

More specifically, two engaging elements 140A and 140B adjacent to each other in the moving direction B are arranged so as to partially overlap in the moving direction B.

Specifically, an engaging portion 142 of the engaging element 140A and an engaging portion 142 of the engaging element 140B are arranged so as to overlap in the moving direction B.

In the engaging sheet 230 of the third embodiment, as shown in FIG. 6C, engaging elements 240 are arranged at predetermined intervals in a staggered pattern.

More specifically, with two engaging element rows 250A and 250B adjacent to each other, the positions of the respective engaging elements 240A constituting the engaging element row 250A and the positions of the respective engaging elements 240B constituting the engaging element row 250B are different from each other in the conveying direction A.

The respective engaging elements 240A and the respective engaging elements 240B are arranged so as to face directions different from each other. More specifically, while the engaging elements 240A extend so as to be long along the moving direction B, the respective engaging elements 240B extend so as to be long along the conveying direction A.

In the engaging sheet 330 of the fourth embodiment, as shown in FIG. 6D, engaging elements 340 are arranged at predetermined intervals in an orthogonal grid pattern.

More specifically, the respective engaging elements 340 are arranged in series along the conveying direction A and the moving direction B, and are regularly arranged at even intervals.

In the engaging sheet 430 of the fifth embodiment, as shown in FIG. 6E, the shapes of engaging elements 440 are different as compared with the engaging sheet 30 shown in FIG. 6A.

The engaging element 440 is an engagement hook with a substantially mushroom-shaped longitudinal section, and an upper surface of the engaging element 440 is a continuous curved surface.

Therefore, a sheet medium S can be easily slid on the upper surfaces (curved surfaces) of the engaging elements 440, and fine positioning of the sheet medium S becomes easier with respect to the sheet holder. The sheet medium S can also be engaged without damage.

In the engaging sheet 530 of the sixth embodiment, as shown in FIG. 6F, engaging elements 540 with inverted J-shaped longitudinal sections are arranged at predetermined intervals in a staggered pattern.

The engaging elements 540 extend so as to become long along the moving direction B.

More specifically, two engaging elements 540A and 540B adjacent to each other in the moving direction B are arranged so as to face directions opposite to each other.

### OTHER EMBODIMENTS

In the embodiment described above, the sheet holder 1 consists of the holder base material 10, the bonding sheet 20, and the engaging sheet 30 as shown in FIG. 4, however, the configuration of the sheet holder is not particularly limited, and can be changed. For example, a sheet holder may be configured without needing the bonding sheet 20.

In the above-described case, the engaging sheet 30 is preferably attached to the holder base material 10 by a publicly known attaching method such as sewing, welding, etc.

In the embodiment described above, the engaging elements 40 are formed as engagement hooks (micro engagement hooks) with T-shaped longitudinal sections as shown in FIG. 4, however, the shapes of the engaging elements 40 are not particularly limited, and can be changed.

For example, the engaging elements 40 may have mushroom-shaped longitudinal sections, inverted J-shaped longitudinal sections, or tree-shaped longitudinal sections.

For example, it is also possible that the engaging element 40 has three or more engaging portions 42, and these engaging portions 42 respectively project outward from the extending end portion of the element main body portion 41.

In the embodiment described above, the alignments of the respective engaging elements 40 common to the engaging element rows 50A and the alignments of the respective engaging elements 40 common to the engaging element rows 50B are formed in a pattern in which they are alternately arranged in the moving direction B as shown in FIG. 5, however, the arrangement is not particularly limited, and can be changed.

For example, the alignments of the respective engaging elements in the engaging element rows 50A and 50B may be alternately arranged every two rows.

Alternatively, for example, it is also possible that in addition to the engaging element rows 50A and 50B, new engaging element rows 50C are also combined, and they are alternately arranged.

In the embodiment described above, the respective engaging elements 40 are arranged at predetermined intervals in the conveying direction A and the moving direction B as shown in FIG. 5, however, the arrangement is not particularly limited, and the respective engaging elements 40 do not have to be arranged at constant intervals.

In the embodiment described above, the respective engaging elements 40 (the respective engaging portions 42) extend so as to be long along the moving direction B as shown in FIG. 4 and FIG. 5, however, the arrangement is not particularly limited, and can be changed.

For example, the respective engaging elements 40 (the respective engaging portions 42) extend so as to be long along the conveying direction A, or extend so as to be long along a direction inclining the moving direction B.

In the embodiments described above, sheet holders according to the present invention are mainly described.

However, the embodiments described above are just examples for easy understanding of the present invention, and are not intended to limit the present invention. As a matter of course, the present invention can be modified and improved without departing from the spirit of the present invention, and equivalents thereto are also included in the present invention.

### REFERENCE SIGNS LIST

P Plotter
P1 Mounting table
P2 Drive roller
P3 Pressure roller
P4 Cutter
P5 Carriage
S Sheet medium
1 Sheet holder
10 Holder base material
10a Attaching region
10b Non-attaching region
11 Reference line
12 Arrow mark
13 Graduation
20 Bonding sheet
30, 130, 230, 330, 430, 530 Engaging sheet
31 Sheet main body
40, 140, 240, 340, 440, 540 Engaging element
41 Element main body portion
42, 142 Engaging portion
42a First projecting portion
42b Second projecting portion
43 Recessed portion
50, 250 Engaging element row
A Conveying direction
B Moving direction
D1, D2, D3 Interval (distance)

1. A sheet holder to be used for a plotter that performs processing on a cloth sheet medium, comprising:
a holder base material on an upper surface of which the sheet medium is mounted; and
an engaging sheet attached onto the holder base material and including a plurality of hook-shaped engaging elements to be engaged with the sheet medium, wherein
the engaging elements are arranged in a plane shape at predetermined intervals on the holder base material.

2. The sheet holder according to claim 1, further comprising a bonding sheet that is provided between the holder base material and the engaging sheet and that bonds the engaging sheet onto the holder base material, wherein
the sheet holder is used for the plotter that performs a cutting process by conveying the sheet medium in a conveying direction intersecting a moving direction of a carriage holding a cutter while moving the carriage in a state where the cutter is in contact with or separated from the sheet medium, and
the holder base material is conveyed along the conveying direction together with the sheet medium in a state where the sheet medium is mounted on the upper surface of the holder base material.

3. The sheet holder according to claim 2, wherein
a plurality of engaging element rows each consisting of a plurality of the engaging elements arranged along the conveying direction are formed and arranged along the moving direction,
positions of the respective engaging elements constituting one of two engaging element rows adjacent to each other and positions of the respective engaging elements constituting the other engaging element row are different from each other in the conveying direction, and
alignments of the respective engaging elements common to the one engaging element rows and alignments of the respective engaging elements common to the other engaging element rows are alternately arranged in the moving direction.

4. The sheet holder according to claim 3, wherein
the engaging elements are formed into substantially T shapes,
each of the engaging elements includes an element main body portion extending upward from the upper surface of the holder base material, and a pair of engaging portions projecting to sides opposite to each other in a direction perpendicular to the extending direction of the element main body portion from an extending end portion of the element main body portion, and
the pair of engaging portions respectively project along the conveying direction or the moving direction.

5. The sheet holder according to claim 4, wherein
the element main body portion is formed to become narrower in width as it extends upward from the upper surface of the holder base material,
the engaging portions project from the extending end portion of the element main body portion while curving downward, and
at a central portion of an upper surface of the engaging element, a recessed portion recessed toward the holder base material side is formed.

6. The sheet holder according to claim 2, wherein
the engaging sheet is a transparent or translucent sheet, and
of the upper surface of the holder base material, in an attaching region to which the engaging sheet is attached, grid-shaped reference lines for engaging the sheet medium with a predetermined position are formed.

7. The sheet holder according to claim 2, wherein
on the upper surface of the holder base material, an attaching region which is provided at a predetermined interval inside an outer peripheral edge of the holder base material and to which the engaging sheet is attached, and a frame-shaped non-attaching region which is provided outside the attaching region and to which the engaging sheet is not attached, are formed.
